(19) United States
(12) Patent Application Publication
(10) Pub. No.: US 2026/0067614 A1
(43) Pub. Date: Mar. 5, 2026

(54) ELECTRONIC DEVICE INCLUDING SPEAKER

(71) Applicant: Samsung Electronics Co., Ltd., Suwon-si (KR)

(72) Inventor: Kwanghyun KIM, Suwon-si (KR)

(21) Appl. No.: 19/269,584

(22) Filed: Jul. 15, 2025

Related U.S. Application Data
(63) Continuation of application No. PCT/KR2025/009063, filed on Jun. 27, 2025.

(30) Foreign Application Priority Data
Sep. 4, 2024 (KR) 10-2024-0119923
Oct. 21, 2024 (KR) 10-2024-0144333

(51) Int. Cl. H04R 1/34; H04R 1/02; H04R 1/24

(52) U.S. Cl. CPC H04R 1/345; H04R 1/025; H04R 1/028; H04R 1/24; H04R 2499/15

(57) ABSTRACT

An electronic device is provided. The electronic device includes a first housing, a speaker housing disposed in the first housing, the speaker housing including a front case and a rear case which is configured to combine with the front case to form an inner space, a first speaker assembly disposed in the speaker housing, including a first speaker, which includes a first diaphragm facing in a first direction, and configured to generate a first acoustic signal corresponding to a first frequency range, and a second speaker assembly disposed in the speaker housing, including a second speaker, which includes a second diaphragm facing in the first direction, and configured to generate a second acoustic signal corresponding to a second frequency range at least partially different from the first frequency range, wherein a first sound path is configured to allow the first acoustic signal to pass therethrough, extends from the first diaphragm toward a first opening in a second direction perpendicular to the first direction and is formed with a portion of the front case, wherein the second speaker is disposed over the first sound path, wherein a guide plate is disposed between the first sound path and the second speaker, and a portion of the guide plate is configured to support the second speaker, and wherein a third sound path is configured to allow the second acoustic signal to pass therethrough, extends from the second diaphragm toward the first opening in the second direction and is formed with a portion of the guide plate.

### CROSS-REFERENCE TO RELATED APPLICATION(S)

This application is a continuation application, claiming priority under 35 U.S. C. § 365(c), of an International application No. PCT/KR2025/009063, filed on Jun. 27, 2025, which is based on and claims the benefit of a Korean patent application number 10-2024-0119923, filed on Sep. 4, 2024, in the Korean Intellectual Property Office, and of a Korean patent application number 10-2024-0144333, filed on Oct. 21, 2024, in the Korean Intellectual Property Office, the disclosure of each of which is incorporated by reference herein in its entirety.

### TECHNICAL FIELD

The disclosure relates to an electronic device. More particularly, the disclosure relates to an electronic device including a speaker.

### BACKGROUND ART

Advancing information communication technologies and semiconductor technologies accelerate the spread and use of various electronic devices. In particular, recent electronic devices are being developed to carry out communication while carried on.

The term “electronic device” may mean a device performing a particular function according to its equipped program, such as a home appliance, an electronic scheduler, a portable multimedia player, a mobile communication terminal, a tablet personal computer (PC), a video/sound device, a desktop PC or laptop computer, a navigation for automobile, and the like. For example, the electronic devices may output stored information as voices or images. As electronic devices are highly integrated, and high-speed, high-volume wireless communication becomes commonplace, an electronic device, such as a mobile communication terminal, is recently being equipped with various functions. For example, an electronic device comes with the integrated functionality, including an entertainment function, such as playing video games, a multimedia function, such as replaying music/videos, a communication and security function, such as for mobile banking, and a scheduling or e-wallet function. These electronic devices have been downsized to be conveniently carried by users.

The above information is presented as background information only to assist with an understanding of the disclosure. No determination has made, and no assertion is made, as to whether any of the above might be applicable as prior art with regard to the disclosure.

### DISCLOSURE OF INVENTION

### Solution to Problems

Aspects of the disclosure are to address at least the above-mentioned problems and/or disadvantages and to provide at least the advantages described below. Accordingly, an aspect of the disclosure is to provide an electronic device including a speaker.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a speaker housing disposed in the first housing, the speaker housing including a front case and a rear case which is configured to combine with the front case to form an inner space, a first speaker assembly disposed in the speaker housing, including a first speaker, which includes a first diaphragm facing in a first direction, and configured to generate a first acoustic signal corresponding to a first frequency range, and a second speaker assembly disposed in the speaker housing, including a second speaker, which includes a second diaphragm facing in the first direction, and configured to generate a second acoustic signal corresponding to a second frequency range at least partially different from the first frequency range, wherein a first sound path is configured to allow the first acoustic signal to pass therethrough, extends from the first diaphragm toward a first opening in a second direction perpendicular to the first direction and is formed with a portion of the front case, wherein the second speaker is disposed over the first sound path, wherein a guide plate is disposed between the first sound path and the second speaker, and a portion of the guide plate is configured to support the second speaker, and wherein a third sound path is configured to allow the second acoustic signal to pass therethrough, extends from the second diaphragm toward the first opening in the second direction and is formed with a portion of the guide plate.

In accordance with another aspect of the disclosure, a speaker assembly is provided. The speaker assembly includes a speaker housing configured to form an inner space, a first speaker assembly disposed in the speaker housing, including a first speaker, which includes a first diaphragm facing in a first direction, and configured to generate a first acoustic signal corresponding to a first frequency range, and a second speaker assembly disposed in the speaker housing, including a second speaker, which includes a second diaphragm facing in the first direction, and configured to generate a second acoustic signal corresponding to a second frequency range at least partially different from the first frequency range, wherein a first sound path is configured to allow the first acoustic signal to pass therethrough, extends from the first diaphragm toward a first opening in a second direction perpendicular to the first direction and is formed with a portion of the speaker housing, wherein the second speaker is disposed over the first sound path, wherein a guide plate is disposed between the first sound path and the second speaker, a portion of the guide plate configured to support the second speaker, and wherein a third sound path is configured to allow the second acoustic signal to pass therethrough, extends from the second diaphragm toward the first opening in the second direction and is formed with a portion of the guide plate.

In accordance with another aspect of the disclosure, an electronic device is provided. The electronic device includes a first housing, a speaker housing disposed in the first housing, the speaker housing including a front case and a rear case which is configured to combine with the front case to form an inner space, a first speaker assembly disposed in the speaker housing, including a first speaker, which includes a first diaphragm facing in a first direction, and configured to generate a first acoustic signal corresponding to a first frequency range, and a second speaker assembly disposed in the speaker housing, including a second speaker, which includes a second diaphragm facing in the first direction, and configured to generate a second acoustic signal corresponding to a second frequency range at least partially different from the first frequency range, wherein a first sound path is configured to allow the first acoustic signal to pass therethrough, extends from the first diaphragm toward a first opening in a second direction perpendicular to the first direction and is formed with a portion of the front case, wherein the second speaker is disposed over the first sound path, wherein a guide plate is disposed between the first sound path and the second speaker, a portion of the guide plate configured to support the second speaker, wherein a third sound path is configured to allow the second acoustic signal to pass therethrough, extends from the second diaphragm toward the first opening in the second direction and is formed with a portion of the guide plate, and wherein the front case and the rear case are coupled to each other by a fastening portion formed in the first housing.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a front perspective view illustrating an electronic device according to an embodiment of the disclosure;

FIG. 3 is a rear perspective view illustrating an electronic device according to an embodiment of the disclosure;

FIG. 4 is an exploded perspective view illustrating a portion of an electronic device according to an embodiment of the disclosure;

FIG. 5 is a perspective view illustrating a speaker assembly according to an embodiment of the disclosure;

FIG. 6 is a plan view illustrating a portion of an electronic device according to an embodiment of the disclosure;

FIG. 7 is a cross-sectional view illustrating an electronic device, taken along line A-A′ of FIG. 6 according to an embodiment of the disclosure;

FIG. 8 is a partially enlarged cross-sectional view illustrating an electronic device, taken along line A-A′ of FIG. 6 according to an embodiment of the disclosure;

FIG. 9 is a partially enlarged cross-sectional view illustrating an electronic device, taken along line A-A′ of FIG. 6 according to an embodiment of the disclosure;

FIG. 10 is a perspective view illustrating a speaker assembly according to an embodiment of the disclosure;

FIG. 11 is a bottom view illustrating a speaker assembly according to an embodiment of the disclosure;

FIG. 12 is a perspective view illustrating a speaker assembly according to an embodiment of the disclosure;

FIG. 13 is a bottom view illustrating a speaker assembly according to an embodiment of the disclosure;

FIG. 14 is a bottom view illustrating a speaker assembly according to an embodiment of the disclosure;

FIG. 15 is a perspective view illustrating a portion of an electronic device according to an embodiment of the disclosure;

FIG. 16 is a cross-sectional view illustrating an electronic device, taken along line B-B′ of FIG. 12 according to an embodiment of the disclosure;

FIG. 17 is a cross-sectional view illustrating an electronic device, taken along line C-C′ of FIG. 12 according to an embodiment of the disclosure;

FIG. 18 is a cross-sectional view illustrating a portion of an electronic device according to an embodiment of the disclosure;

FIG. 19 is a cross-sectional view illustrating a portion of an electronic device according to an embodiment of the disclosure;

FIG. 20 is a plan view illustrating a partial cutaway of an electronic device according to an embodiment of the disclosure;

FIG. 21 is a graph illustrating comparison between a speaker assembly according to an embodiment of the disclosure;

FIG. 22 is a cross-sectional view illustrating a portion of an electronic device according to an embodiment of the disclosure;

FIG. 23 is a perspective view illustrating a fastening portion of a rear case of an electronic device according to an embodiment of the disclosure;

FIG. 24 is a plan view illustrating a portion of an electronic device according to an embodiment of the disclosure;

FIG. 25 is a plan view and a partially enlarged view illustrating an electronic device according to an embodiment of the disclosure; and

FIG. 26 is a cross-sectional view illustrating an electronic device according to an embodiment of the disclosure.

Throughout the drawings, like reference numerals will be understood to refer to like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

To enhance the bass reproduction capability of a speaker and increase the output capacity, an electronic device including a long speaker in a third direction (e.g., the Y-axis direction) is required. However, since electronic devices have limited internal structures, it was difficult to provide long speakers in the third direction (e.g., the Y-axis direction).

With recent technological advancements, advanced services are provided by electronic devices, which leads to the need for high-performance audio technology. Therefore, it is necessary to provide a long speaker in the third direction (e.g., the Y-axis direction) within the limited space of the electronic device.

According to an embodiment, the electronic device of the disclosure may enhance sound quality and volume by securing a size of the speaker in the third direction (e.g., the Y-axis direction). Further, it is possible to efficiently utilize the mounting space by minimizing or reducing the mounting space in the third direction (e.g., the Y-axis direction) of the electronic device by allowing the sound paths of a plurality of speakers to overlap each other.

Aspects of the disclosure are not limited to the foregoing, and other unmentioned aspects would be apparent to one of ordinary skill in the art from the following description.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth®chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

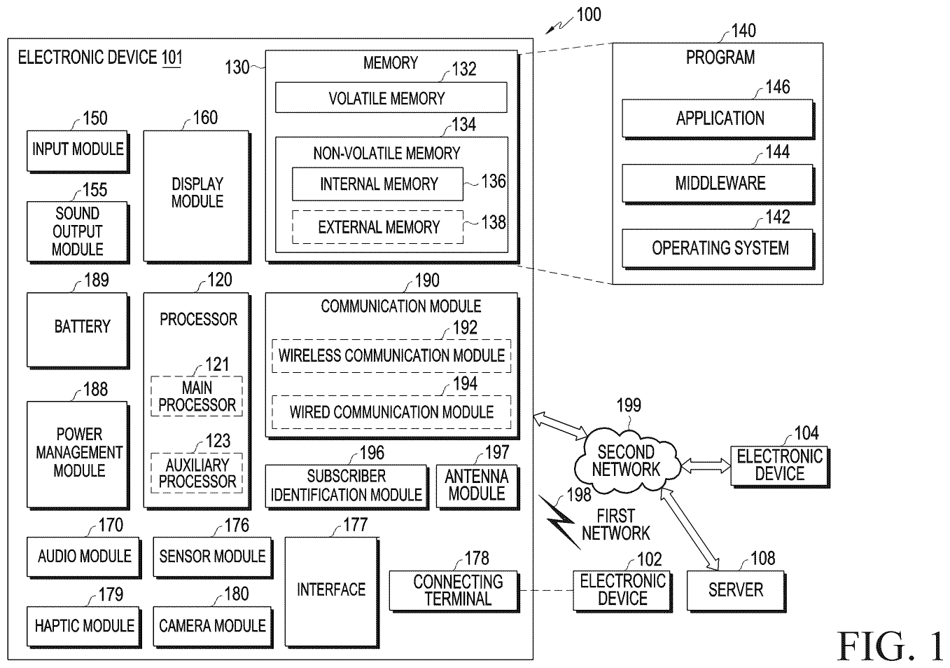

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment of the disclosure may be one of various types of devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

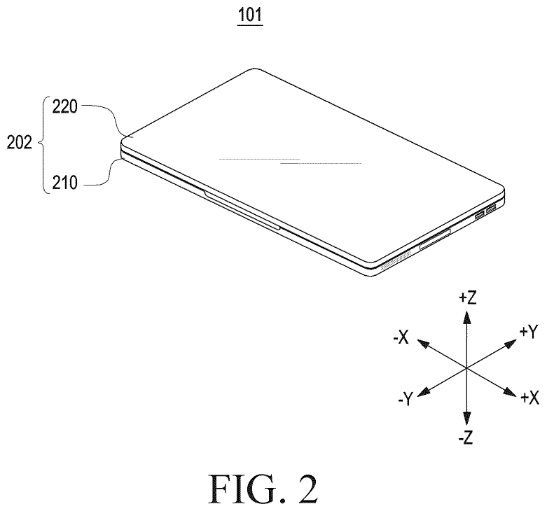

FIG. 2 is a perspective view illustrating an electronic device in a folded state according to an embodiment of the disclosure.

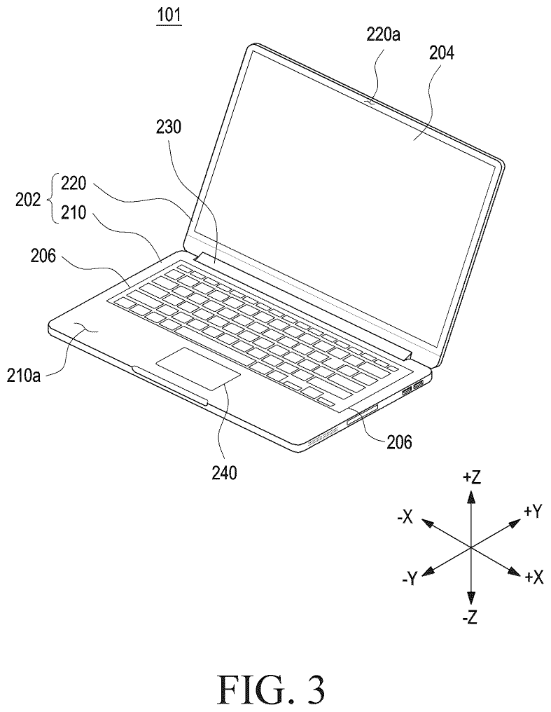

FIG. 3 is a perspective view illustrating an electronic device in an unfolded state according to an embodiment of the disclosure.

In the following detailed description, a length direction, a width direction, and/or a thickness direction of the electronic device may be mentioned and may be defined as a ‘Y-axis direction,’ ‘X-axis direction’, and/or ‘Z-axis direction,’ respectively. In an embodiment, ‘negative/positive (−/+)’ may be mentioned together with the Cartesian coordinate system exemplified in the drawings with respect to the direction in which the component is oriented. For example, the front surface of the electronic device and/or housing may be defined as a ‘surface facing in the +Z direction,’ and the rear surface may be defined as a ‘surface facing in the −Z direction’. In an embodiment, the side surface of the electronic device and/or housing may include an area facing in the +X direction, an area facing in the +Y direction, an area facing in the −X direction, and/or an area facing in the −Y direction. In an embodiment, the ‘X-axis direction’ may mean including both the ‘-X direction’ and the ‘+X direction’. Hereinafter, in the description of the electronic device 101 described below, the ‘first direction’ may mean the Z-axis direction (or a direction parallel to the Z-axis), the ‘second direction’ may mean the X-axis direction (or a direction parallel to the X-axis), and the ‘third direction’ may mean the Y-axis direction (or a direction parallel to the Y-axis). It should be noted that the directions are so defined with respect to the Cartesian coordinate system shown in the drawings for the sake of brevity of description, and the description of these directions or components do not limit an embodiment(s) of the disclosure. For example, the Cartesian coordinate system may be defined as different from that disclosed in the disclosure depending on the specifications of the electronic device or the user's usage habits.

Referring to FIGS. 2 and 3, an electronic device 101 may include a housing 202, a display 204, and a touch pad module 240. According to an embodiment, the electronic device 101 may be a laptop computer, a notebook computer, or a portable terminal. The configuration of the electronic device 101 of FIGS. 2 and 3 may be identical in whole or part to the configuration of the electronic device 101 of FIG. 1.

According to an embodiment, the housing 202 may form at least a portion of the exterior of the electronic device 101 or support a component (e.g., the touch pad module 240) of the electronic device 101. For example, the housing 202 may receive at least one of the display 204, the input device 206, or the touch pad module 240.

According to an embodiment, the electronic device 101 may be opened (e.g., FIG. 3) or closed (e.g., FIG. 2). For example, the housing 202 may include a first housing 210 and a second housing 220 connected to be rotatable with respect to the first housing 210. According to an embodiment, the electronic device 101 may include a hinge structure 230 connected to the second housing 220. For example, the hinge structure 230 may be connected to the first housing 210 and the second housing 220. According to an embodiment, the first housing 210 may be configured to rotate by a designated angle (e.g., 0 degrees to 180 degrees, or 0 degrees to 360 degrees) with respect to the second housing 220. According to an embodiment, the second housing 220 may be represented, defined, and/or interpreted as rotating to a designated angle with respect to the first housing 210. For example, in the closed state (e.g., FIG. 2) of the electronic device 101, a first front surface 210a of the first housing 210 may face a second front surface 220a of the second housing 220.

According to an embodiment, the housing 202 may be formed of a metallic material or a non-metallic material having a selected magnitude of rigidity. According to an embodiment, at least a portion of the electronic device 101 formed of the metallic material may provide a ground plane and may be electrically connected to a ground line formed on a printed circuit board. For example, the housing 202 may be electrically connected to the printed circuit board through a capacitive component.

According to an embodiment, at least a portion of the display 204 may be disposed in the second housing 220. For example, at least a portion of the display 204 may be visually exposed to the outside of the electronic device 101 through the second housing 220. The display 204 may form at least a portion of a second front surface 220a of the second housing 220. According to an embodiment, the display 204 may be a flexible display in which at least a partial area thereof may be deformed into a flat surface and/or a curved surface. For example, the display 204 may be a foldable or rollable display. The configuration of the display 204 may be identical in whole or part to the configuration of the display module 160 of FIG. 1.

According to an embodiment, the display 204 may be coupled with or disposed adjacent to a touch detection circuit, a pressure sensor capable of measuring the strength (pressure) of touches, and/or a digitizer for detecting a magnetic field-type stylus pen.

According to an embodiment, the input device 206 may detect a user input (e.g., pressure). According to an embodiment, the input device 206 may be disposed or received on the first housing 210. According to an embodiment, in the closed state of the electronic device 101, the input device 206 may face the display 204. The configuration of the input device 206 of FIG. 2 may be identical in whole or part to the configuration of the input module 150 of FIG. 1. For example, the input device 206 may be a keyboard.

According to an embodiment, the touch pad module 240 may be configured to detect or receive a user input. According to an embodiment, the touch pad module 240 may include a capacitive touch sensor, a touch sensor based on resistance detection, an optical touch sensor, or a surface sound wave touch sensor. For example, the touch pad module 240 detects current, pressure, light, and/or vibration due to the input applied by the user to the touch pad module 240, and the processor (e.g., processor 120 of FIG. 1) and/or the touch pad module 240 may determine the user input based on a change in the detected current, pressure, light, and/or vibration. According to an embodiment, the touch pad module 240 may be referred to as a touch pad, a touch pad device, or a touch pad structure.

According to an embodiment, the processor (e.g., the processor 120 of FIG. 1) and/or the touch pad module 240 may determine the input position (e.g., XY coordinates) of the user. According to an embodiment, the touch pad module 240 may detect pressure on the touch pad module 240. For example, the touch pad module 240 may sense a force in the thickness direction (e.g., the Z-axis direction) using a switch and at least one force sensor. According to an embodiment, the touch pad module 240 may detect an external object when the external object (e.g., the user's finger or a stylus) directly contacts or is close to the surface of the touch pad module 240.

According to an embodiment, the touch pad module 240 may be received in the housing 202. For example, the touch pad module 240 may be connected to the first housing 210, and at least a portion of the touch pad module 240 may be exposed to the outside of the first housing 210. According to an embodiment, the touch pad module 240 may be adjacent to the input device 206. According to an embodiment, in the closed state of the electronic device 101, at least a portion of the touch pad module 240 may face the display 204. The configuration of the touch pad module 240 may be identical in whole or part to the configuration of the input module 150 of FIG. 1.

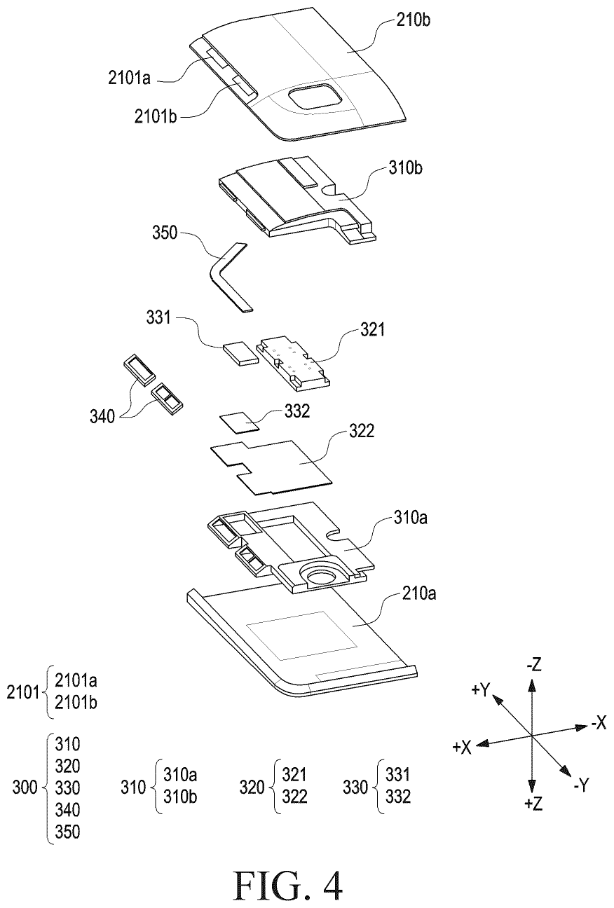

FIG. 4 is an exploded perspective view illustrating a portion of an electronic device according to an embodiment of the disclosure.

Referring to FIG. 4, the electronic device 101 may include a housing 210. The description of the housing 210 made with reference to FIGS. 1 to 3 may apply to the description of the housing 210. The first housing 210 of the electronic device 101 may include a first front surface 210a and a first rear surface 210b. As described above, the first front surface 210a may face the second front surface 220a of the second housing 220 described above with reference to FIG. 2. Further, the first rear surface 210b is a portion that is visually exposed to the outside of the electronic device 101 despite whether the electronic device 101 is opened (e.g., FIG. 3) or closed (e.g., FIG. 2), and may protect the internal components of the electronic device 101 from external impact.

A hole 2101 may be formed in one end portion of the first rear surface 210b. According to an embodiment, the first rear surface 210b of the housing 210 may include a planar area and a curved area extending from one end portion of the planar area. The hole 2101 may be formed in the curved area. Further, the sound emitted from the first speaker 321 and/or the second speaker 331 may be transferred to the outside of the electronic device 101 through the hole 2101.

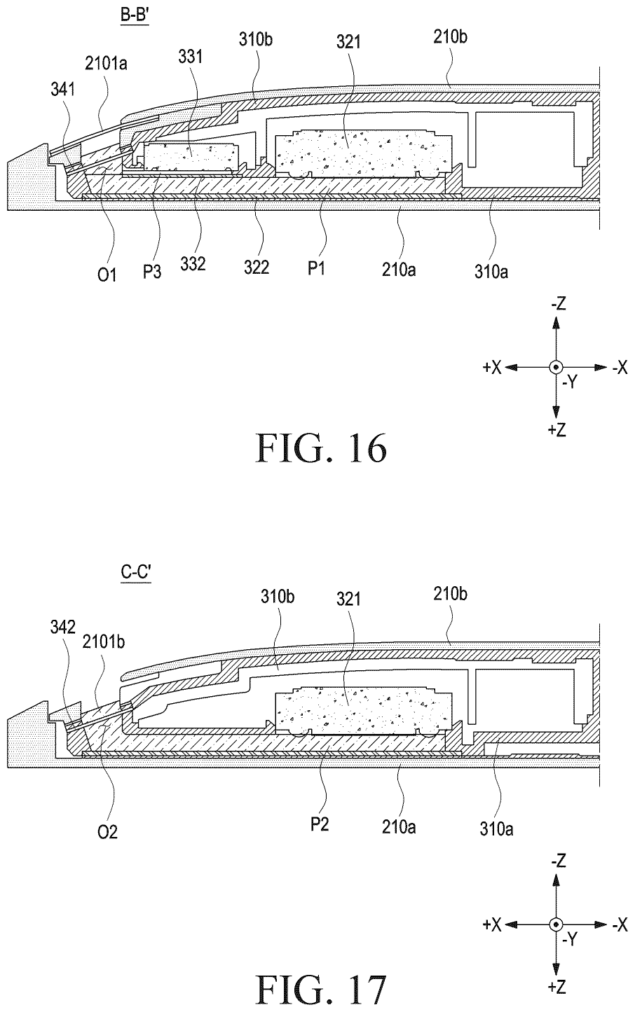

The hole 2101 may be, e.g., an empty space where an opening (e.g., the first opening O1 of FIG. 16 and/or the second opening O2 of FIG. 17) to be described below is formed. Further, the hole 2101 may be configured to include a diffuser (e.g., a structure where a plurality of small holes are formed) for uniformly dispersing the sound emitted from the speaker assembly 300. According to an embodiment, the hole 2101 may further include a mesh member, and the mesh member may be configured to cover the hole 2101.

According to an embodiment, the hole 2101 may include a first hole 2101a and a second hole 2101b. The first hole 2101a may include a first plurality of holes, and the second hole 2101b may include a second plurality of holes.

According to an embodiment, the housing 210 may further include a first mesh member covering the first hole 2101a and a second mesh member covering the second hole 2101b. Further, a first plurality of holes aligned with the first hole 2101a may be formed in the first mesh member, and a second plurality of holes aligned with the second hole 2101b may be formed in the second mesh member.

The shape of the exterior of the hole 2101 may be a shape for minimizing or reducing distortion of sound emitted from the first speaker 321 and/or the second speaker 331. Accordingly, the sound quality of sound transferred to the outside of the electronic device 101 may be enhanced. For example, the exterior of the hole 2101 may have a shape corresponding to a radiating portion 340 to be described below, and may have a shape where a plurality of small holes are formed.

According to an embodiment, the first hole 2101a may be configured to transfer sound emitted from the first speaker 321 and/or the second speaker 331 to the outside, and the second hole 2101b may be configured to transfer sound emitted from the first speaker 321 to the outside.

According to an embodiment, the sound emitted from the first hole 2101a may be a sound where the sound emitted from the first speaker 321 and the sound emitted from the second speaker 331 overlap. According to an embodiment, it is possible to minimize or reduce the overlap between the emitted sounds by operating the first speaker 321 and the second speaker 331 at different frequencies. For example, the first speaker 321 may be a speaker that emits a sound corresponding to a low frequency, and the second speaker 331 may be a speaker that emits a sound corresponding to a high frequency.

According to an embodiment, the first speaker 321 may emit sound having a frequency equal to or smaller than a designated frequency value (e.g., 3 kHz) in an audible frequency range. The second speaker 331 may emit a sound having a frequency exceeding the designated frequency value (e.g., 3 kHz) in the audible frequency range. However, this is merely an example, and the example of the frequency value may vary according to embodiments. According to an embodiment, the frequency ranges of the sounds emitted from the first speaker 321 and the sound emitted from the second speaker 331 may overlap each other. However, for convenience of description below, the frequency ranges of the emissions from the first speaker 321 and the second speaker 331 are different. For example, the first speaker 321 may be configured to form a woofer, and the second speaker 331 may be configured to form a tweeter.

The woofer may be, e.g., a speaker that reproduces low-frequency sound. The woofer may be a speaker that reproduces sound of 200 Hz or less, and may effectively transfer the sound of a bass instrument such as a bass, a guitar, or a drum. For this reason, the woofer may be a speaker using a large-sized driver. The tweeter may be, e.g., a speaker that reproduces high-frequency sound. The tweeter may be a speaker that reproduces a sound of a frequency of 2 kHz or more, and may clearly transfer the sound of a high-pitched instrument. For this reason, the twitter may be a speaker that uses a driver smaller than the woofer.

According to an embodiment, when the first speaker 321 and the second speaker 331 emit sounds of different frequencies, the operating times of the first speaker 321 and the second speaker 331 may vary according to the frequency of the sound that the speaker assembly 300 intends to emit. Accordingly, distortion of sounds output from the first speaker 321 and the second speaker 331 may be prevented or decreased. In other words, even when both the sound emitted from the first speaker 321 and the sound emitted from the second speaker 331 are emitted through the first hole 2101a, a phenomenon where sounds overlap and are distorted may be minimized or removed.

In the illustrations and the following embodiments, an example in which, as the hole 2101, a first hole 2101a and a second hole 2101b are separated from each other is described, but the disclosure is not limited thereto. According to an embodiment, the first hole 2101a and the second hole 2101b may be connected to each other to form one hole 2101.

The speaker assembly 300 may include a speaker housing 310, a first speaker assembly 320, a second speaker assembly 330, a radiating portion 340, and a cable 350. The sound emitted from the speaker assembly 300 may be transferred to the outside through the hole 2101 of the electronic device 101.

According to an embodiment, a space formed to be spaced apart from the hole 2101 of the electronic device 101 by a predetermined distance in the second direction (e.g., the X-axis direction) may be defined as a first resonance space. Further, a space formed between the hole 2101 of the electronic device 101 and the first resonance space may be defined as a second resonance space. According to an embodiment, the first resonance space and the second resonance space may be disposed adjacent to each other in the second direction (e.g., the X-axis direction). Further, the first speaker assembly 320 may be disposed in the first resonance space and the second speaker assembly 330 may be disposed in the second resonance space, so that the first speaker assembly 320 and the second speaker assembly 330 may be disposed adjacent to each other in the second direction (e.g., the X-axis direction).

Although only one speaker assembly 300 formed at one end portion of the electronic device 101 in the second direction (e.g., the +X-axis direction) is described in the present illustration and the following embodiment, the speaker assembly 300 may be positioned at two opposite ends with respect to the second direction (e.g., the X-axis direction) of the electronic device 101.

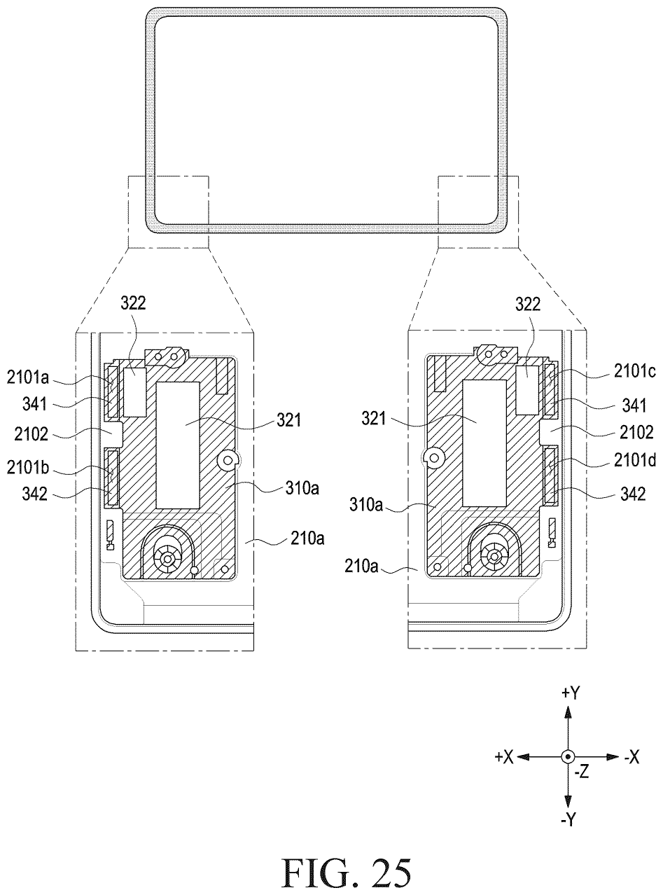

According to an embodiment, the housing 210 may have a third hole (e.g., the third hole 2101c of FIG. 25) and a fourth hole (e.g., the fourth hole 2101d of FIG. 25) formed at the other end portion opposite to the one end portion where the first hole 2101a and the second hole 2101b are formed.

According to an embodiment, the third hole (e.g., the third hole 2101c of FIG. 25) may be configured to transfer sound emitted from the third speaker and/or the fourth speaker to the outside, and the fourth hole (e.g., the fourth hole 2101d of FIG. 25) may be configured to transfer sound emitted from the third speaker to the outside.

The speaker housing 310 may include a front case 310a and a rear case 310b. The speaker housing 310 may support the first speaker assembly 320 and/or the second speaker assembly 330 and protect the speaker assembly 300 from external impact. Further, the speaker housing 310 may guide the sound emitted from the first speaker 321 and/or the second speaker 331. Further, the speaker housing 310 may be coupled or integrally formed with the housing 210 described above.

According to an embodiment, the front case 310a may face the first front surface 210a of the electronic device 101, and the rear case 310b may face the first rear surface 210b of the electronic device 101. As a result, at least a portion of the speaker housing 310 may be supported by the first front surface 210a and/or the first rear surface 210b of the electronic device 101, and the speaker assembly 300 may be disposed in the inner space of the electronic device 101. Further, the front case 310a and the rear case 310b may be coupled and fixed inside the electronic device 101 by a fastening portion (e.g., the fastening portion 2102 of FIG. 6) to minimize or reduce the sound shaking caused by the vibration of the speaker assembly 300.

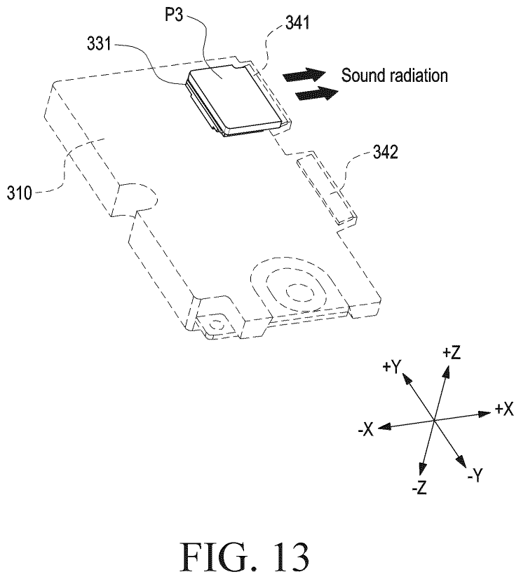

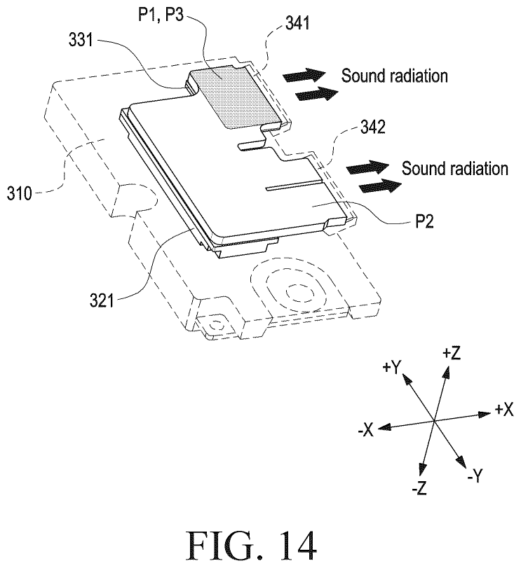

The speaker housing 310 may be configured to form at least a portion of a first sound path (e.g., the first sound path P1 of FIG. 14) to be described below, at least a portion of a second sound path (e.g., the second sound path P2 of FIG. 13) to be described below, and at least a portion of a third sound path (e.g., the third sound path P3 of FIG. 14) to be described below.

The first speaker assembly 320 may include a first speaker 321 and a first plate 322. As described above, the first speaker 321 may be configured to emit a low-frequency sound, and the first plate 322 may guide the sound emitted from the first speaker 321 to the hole 2101. Although the first plate 322 is described as a component separated from the speaker housing 310 in the present illustration and the following embodiment, the disclosure is not limited thereto, and it may be at least a portion of the front case 310a.

The second speaker assembly 330 may include a second speaker 331 and a guide plate 332. As described above, the second speaker 331 may be a component for emitting a high-frequency sound, and the guide plate 332 may guide the sound emitted from the second speaker 331 to the hole 2101. Although the guide plate 332 is described as a component separated from the speaker housing 310 in the preset illustration and the following embodiment, the disclosure is not limited thereto, and the guide plate 332 may be formed by extending at least a portion of the rear case 310b.

According to an embodiment, the first speaker 321 may be configured to generate a first acoustic signal corresponding to the first frequency range, and the second speaker 331 may generate a second acoustic signal corresponding to a second frequency range at least partially different from the first frequency range as described above. Further, the first frequency range may cover a frequency band lower than the second frequency range. The first speaker 321 may be configured to form a woofer, and the second speaker 331 may be configured to form a tweeter. Accordingly, the area of the first speaker 321 may be larger than the area of the second speaker 331.

According to an embodiment, a third speaker assembly including a third speaker configured to generate a third acoustic signal corresponding to the first frequency range, and a fourth speaker assembly including a fourth speaker configured to generate a fourth acoustic signal corresponding to the second frequency range may be formed at the other end portions of the first speaker assembly 320 and the second speaker assembly 330. The third speaker may be a speaker corresponding to the first speaker 321, and the fourth speaker may be a speaker corresponding to the second speaker 331. Further, the third speaker and the fourth speaker may emit sound through a third hole (e.g., the third hole 2101c of FIG. 25) and a fourth hole (e.g., the fourth hole 2101d of FIG. 25) corresponding to the first hole 2101a and the second hole 2101b.

As described above, the radiating portion 340 may have a shape corresponding to the exterior of the hole 2101 of the electronic device 101. According to an embodiment, the radiating portion 340 may be formed in an opening (e.g., the first opening O1 of FIG. 16 and/or the second opening O2 of FIG. 17) to be described below, and may guide the sound guided from the first plate 322 and/or the guide plate 332 to the hole 2101 through an opening (e.g., the first opening O1 of FIG. 16 and/or the second opening O2 of FIG. 17) to be described below.

The cable 350 may be used for a general purpose of supplying power to the speaker assembly 300 or transferring a signal by an instruction stored in the memory 130.

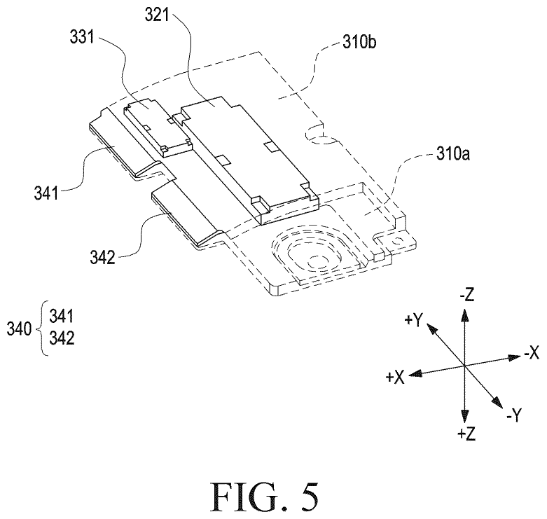

FIG. 5 is a perspective view illustrating a speaker assembly according to an embodiment of the disclosure.

Referring to FIG. 5, the first speaker 321 may have a rectangular parallelepiped shape elongated in a third direction (e.g., the Y-axis direction). The first speaker 321 may emit sound in a first direction (e.g., the +Z-axis direction), for example. The first speaker 321 may include a first diaphragm facing a first direction (e.g., the +Z-axis direction) and generating a first acoustic signal in the first direction (e.g., the +Z-axis direction) through vibration.

According to an embodiment, the first speaker 321 may be a speaker that emits a sound in a low frequency range. For example, the sound in the low frequency range of the first speaker 321 may be a frequency corresponding to a range between 20 Hz and 200 Hz. According to an embodiment, the first acoustic signal may be an acoustic signal in a low frequency range. According to an embodiment, the first acoustic signal may be an acoustic signal of a frequency generally corresponding to a range between 20 Hz and 200 Hz.

According to an embodiment, the first acoustic signal, which is a sound emitted from the first speaker 321, may be guided in the second direction (e.g., the +X-axis direction) by the first plate 322 described above. The first acoustic signal guided by the first plate 322 may pass through the first radiating portion 341 and/or the second radiating portion 342 and may be transferred to the outside of the electronic device 101 through the first hole 2101a and/or the second hole 2101b formed in the first rear surface 210b. The first acoustic signal guided by the first plate 322 may be transferred to the outside of the electronic device 101 through the first opening O1 and/or the second opening O2.

According to an embodiment, the second speaker 331 may be disposed between the first speaker 321 and the first radiating portion 341. According to an embodiment, the second speaker 331 may be disposed between the first hole 2101a and the first speaker 321 when viewed from above. Further, the second speaker 331 may have a rectangular parallelepiped shape long in the third direction (e.g., the Y-axis direction) and may have a shorter length in the third direction (e.g., the Y-axis direction) than the first speaker 321.

The second speaker 331 may emit sound in the first direction (e.g., the +Z-axis direction), for example. The second speaker 331 may include a second diaphragm facing the first direction (e.g., the +Z-axis direction) and generating a second acoustic signal in the first direction (e.g., the +Z-axis direction) through vibration.

According to an embodiment, the second speaker 331 may be a speaker that emits a sound in a high frequency range. For example, a sound in a high frequency range of the second speaker 331 may be a frequency corresponding to a range between 2 kHz and 20 kHz. According to an embodiment, the second acoustic signal may be an acoustic signal in a high frequency range. According to an embodiment, the second acoustic signal may be an acoustic signal of a frequency generally corresponding to a range between 2 kHz and 20 kHz.

According to an embodiment, the second acoustic signal, which is a sound emitted from the second speaker 331, may be guided in the second direction (e.g., the +X-axis direction) by the guide plate 332 described above. The second acoustic signal, which is a sound guided by the guide plate 332, may pass through the first radiating portion 341 and be transferred to the outside of the electronic device 101 through the first hole 2101a formed in the first rear surface 210b. The second acoustic signal guided by the guide plate 332 may be transferred to the outside of the electronic device 101 through the first opening O1.

In the preset illustration and the following embodiment, an example in which, as the radiating portion 340, the first radiating portion 341 and the second radiating portion 342 are separated from each other is described, but the disclosure is not limited thereto. According to an embodiment, the first radiating portion 341 and the second radiating portion 342 may be connected to form one radiating portion 340.

According to an embodiment, when the radiating portion 340 is formed to be longer than a predetermined value, the sound quality of sound emitted from the first speaker 321 and/or the second speaker 331 may be deteriorated due to vibration generated from the speaker assembly 300.

When the radiating portion 340 is formed to be separated, the front case 310a and the rear case 310b may be coupled through a fastening portion (e.g., the fastening portion 2102 of FIG. 6) formed between the first radiating portion 341 and the second radiating portion 342 to be described below, thereby reducing the intensity of vibration generated in the speaker assembly 300.

In the present illustration and the following embodiment, an example is described in which the first speaker 321 and the second speaker 331 are rectangular parallelepiped elongated in the third direction (e.g., the Y-axis direction), but are not limited thereto and may have a general speaker shape.

According to an embodiment, at least a portion of the second speaker 331 may be disposed adjacent to the first speaker 321 in the second direction (e.g., the X-axis direction). Thus, at least a portion of the first acoustic signal, which is sound emitted from the first speaker 321, and the second acoustic signal, which is sound emitted from the second speaker 331, may pass through the first radiating portion 341 disposed in parallel in the second direction (e.g., the X-axis direction). For this reason, the sounds passing through the first radiating portion 341 may overlap in an opening (e.g., the first opening O1 of FIG. 16 and/or the second opening O2 of FIG. 17) to be described below.

According to an embodiment, since the first speaker 321 and the second speaker 331 are disposed adjacent to each other in the second direction (e.g., the X-axis direction), the length of the first speaker 321 in the third direction (e.g., the Y-axis direction) may extend up to the maximum length of the electronic device 101 in the third direction (e.g., the Y-axis direction) despite the limit to the length in the third direction (e.g., the Y-axis direction) of the electronic device 101.

FIG. 6 is a plan view illustrating a portion of an electronic device according to an embodiment of the disclosure.

Referring to FIG. 6, a rear case 310b may be formed in the first direction (e.g., the +Z axis direction) of the first rear surface 210b of the electronic device 101. According to an embodiment, the rear case 310b may at least partially overlap the first rear surface 210b when viewed from above. The hole 2101 formed in the first rear surface 210b of the electronic device 101 may be disposed further outside the electronic device 101 than the radiating portion 340 formed at one end portion of the speaker assembly 300. According to an embodiment, the radiating portion 340 may at least partially overlap the hole 2101 when viewed from above.

According to an embodiment, the first rear surface 210b may further include a fastening portion 2102. Although an example is described in which, as a fastening method through the fastening portion 2102, the first front surface 210a and the first rear surface 210b are fastened in a hook structure in the present illustration and the following embodiment, the disclosure is not limited thereto. However, the fastening method through the fastening portion 2102 is not limited thereto, and various fastening methods may be adopted according to the shape of the fastening portion 2102 and/or the speaker housing 310. For example, the first front surface 210a and the first rear surface 210b may be fastened using a screw structure.

The fastening portion 2102 may be formed between the first and second radiating portions 341 and 342. The fastening portion 2102 may couple and fix the front case 310a and the rear case 310b between the first and second radiating portions 341 and 342. Accordingly, it is possible to enhance sound quality by mitigating sound vibration occurring in the first speaker 321 and/or the second speaker 331 and minimizing or reducing vibration noise.

Although it is described in the present illustration that the fastening portion 2102 is included in the first housing 210, the disclosure is not limited thereto, and it may be formed in the front case 310a and the rear case 310b of the speaker housing 310. For example, the front case 310a and the rear case 310b may be fastened in a hook structure.

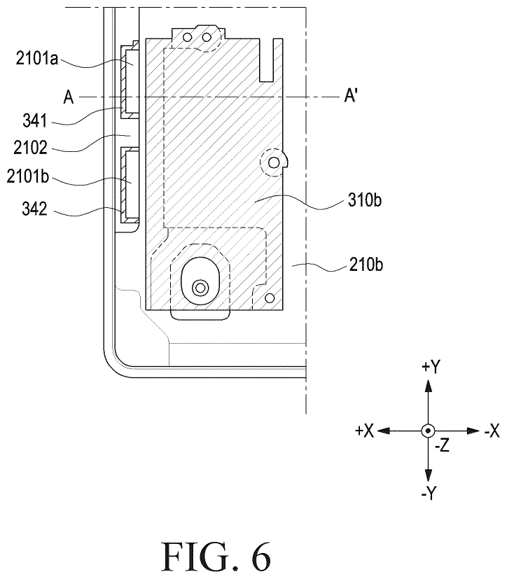

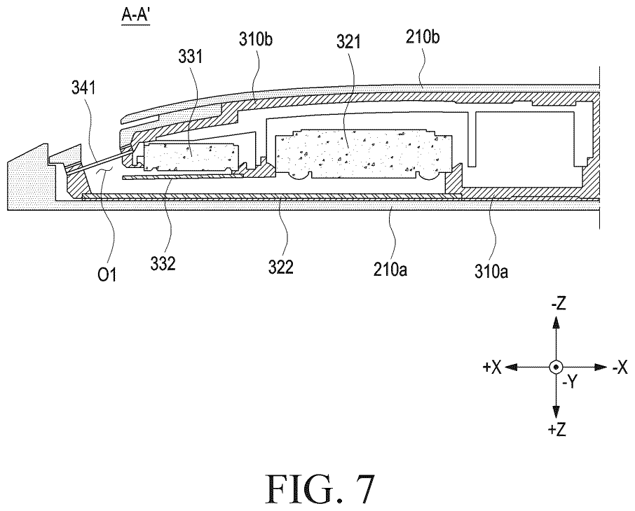

FIG. 7 is a cross-sectional view illustrating an electronic device, taken along line A-A′ of FIG. 6 according to an embodiment of the disclosure.

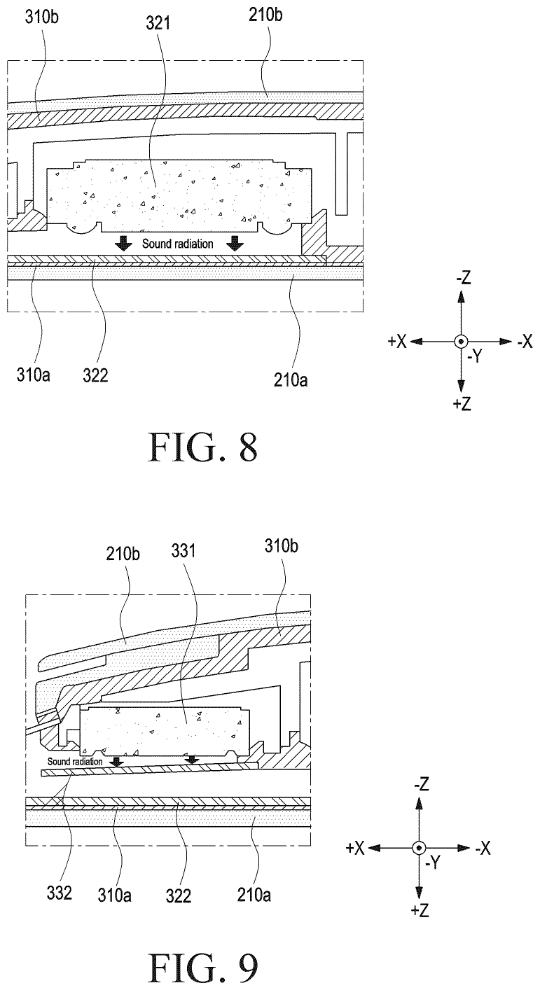

FIG. 8 is a partially enlarged cross-sectional view illustrating an electronic device, taken along line A-A′ of FIG. 6 according to an embodiment of the disclosure.

FIG. 9 is a partially enlarged cross-sectional view illustrating an electronic device, taken along line A-A′ of FIG. 6 according to an embodiment of the disclosure.

Referring to FIGS. 7 to 9, at least a portion of the first speaker 321 and/or the second speaker 331 may be supported by the front case 310a and/or the rear case 310b. Further, the second speaker 331 may be disposed further outside the electronic device 101 with respect to the second direction (e.g., the +X-axis direction) than the first speaker 321.

According to an embodiment, the first speaker 321 is disposed on at least a portion of the first plate 322 and may emit sound in the first direction (e.g., the +Z-axis direction). The sound emitted through the first speaker 321 may be guided in the second direction (e.g., the +X-axis direction) by the first plate 322 and transferred to the first opening O1. Further, the first speaker 321 may be a speaker having a longer length in the second direction (e.g., the X-axis direction) and/or the first direction (e.g., Z-axis direction) than the second speaker 331. Further, the first plate 322 may be elongated in the second direction (e.g., the X-axis direction), two opposite end portions may be coupled to the front case 310a and/or the rear case 310b, and one end portion may extend to the first opening O1 in the second direction (e.g., the X-axis direction).

According to an embodiment, the second speaker 331 is disposed on at least a portion of the guide plate 332 and may emit sound in the first direction (e.g., the +Z-axis direction). The sound emitted through the second speaker 331 may be guided in the second direction (e.g., the +X-axis direction) by the guide plate 332 and transferred to the first opening O1. Further, the guide plate 332 may be disposed on at least a portion of the first plate 322. Further, the guide plate 332 may be elongated in the second direction (e.g., the X-axis direction), and one end portion may be coupled to the front case (310a). Further, the other end portion of the guide plate 332 may extend to the first opening O1 in the second direction (e.g., the X-axis direction).

According to an embodiment, sound emitted from the first speaker 321 and/or the second speaker 331 to the first opening O1 may pass through the first radiating portion 341 and be emitted to the outside of the electronic device 101.

Although an example is described in which the first plate 322 and/or the guide plate 332 is separated from the speaker housing 310 in the present illustration and the following embodiment, the first plate 322 and/or the guide plate 332 may be integrated with the speaker housing 310.

In the present illustration and the following embodiment, an example is described in which the first speaker 321 and/or the second speaker 331 is supported in contact with the speaker housing 310, and does not contact the first plate 322 and/or the guide plate 332, but the disclosure is not limited thereto. According to an embodiment, the first speaker 321 and/or the second speaker 331 may be supported in contact by the first plate 322 and/or the guide plate 332.

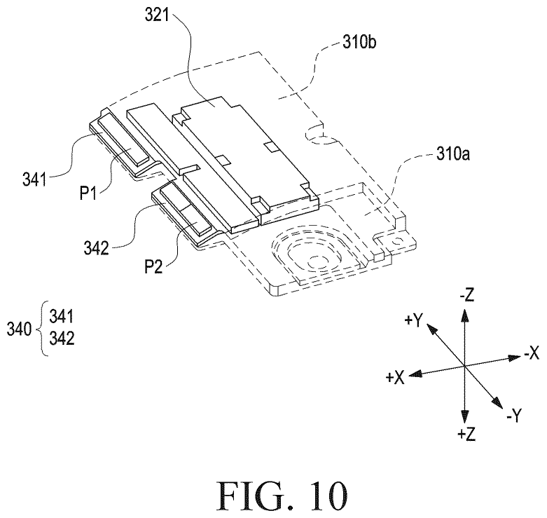

FIG. 10 is a perspective view illustrating a speaker assembly according to an embodiment of the disclosure.

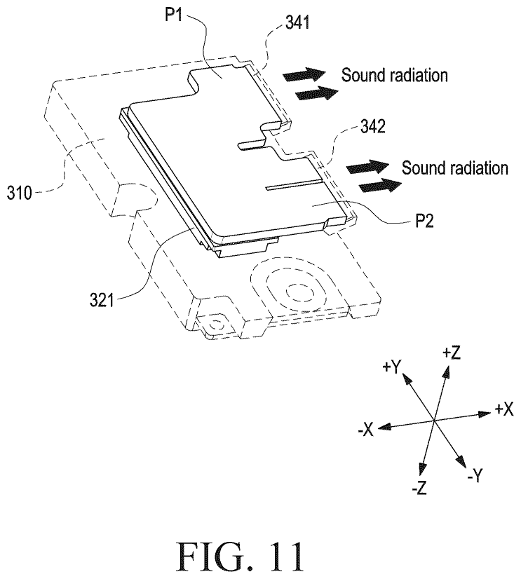

FIG. 11 is a bottom view illustrating a speaker assembly according to an embodiment of the disclosure.

Referring to FIGS. 10 and 11, a sound path through which sound emitted from the first speaker 321 is emitted may be defined as a sound path of the first speaker 321. The first acoustic signal, which is sound emitted from the first speaker 321, may move along the sound path of the first speaker 321, and may be transferred to the outside of the electronic device 101 through the openings O1 and O2.

The sound path may mean a path through which sound is transferred in the process of reaching the user from the position where the sound is generated (e.g., the first speaker 321 and/or the second speaker 331). According to an embodiment, a conduit having a certain shape formed by at least a portion of the speaker housing 310, the first plate 322, and/or the guide plate 332 is formed, and a path through which sound is transferred in the process of reaching the user from the position where sound is generated (e.g., the first speaker 321 and/or the second speaker 331) of the conduit may be referred to as a sound path.

According to an embodiment, the sound path of the first speaker 321 may be a path through which the first acoustic signal is emitted from the first diaphragm and moves in the second direction perpendicular to the first direction, and is emitted through the first opening O1 and/or the second opening O2. Further, the sound path of the first speaker 321 may include a first sound path P1 and a second sound path P2.

According to an embodiment, a path through which the sound emitted from the first speaker 321 passes through the first radiating portion 341 along the first opening O1 and be discharged may be defined as the first sound path P1. The first sound path P1 may partially overlap a third sound path (e.g., the third sound path P3 of FIG. 14) to be described below. Further, the first sound path P1 may be disposed between the third sound path (e.g., the third sound path P3 of FIG. 14) to be described below and the first front surface 210a of the housing 210.

According to an embodiment, a path through which the sound emitted from the first speaker 321 passes through the second radiating portion 342 along the second opening O2 and be discharged may be defined as the second sound path P2.

In the disclosure and the following embodiment, it is described that the first sound path P1 and the second sound path P2 are distinguished, but the disclosure is not limited thereto, and the sound emitted from the first speaker 321 may move freely inside the speaker housing 310 in the sound path of the first speaker 321.

According to an embodiment, the first sound path P1 formed between the first radiating portion 341 and the first speaker 321 may allow the first portion of the first acoustic signal to be emitted to the outside of the electronic device 101 through the first hole 2101a.

Further, the second sound path P2 formed between the second radiating portion 342 and the first speaker 321 may allow the second portion of the first acoustic signal to be emitted to the outside of the electronic device 101 through the second hole 2101b.

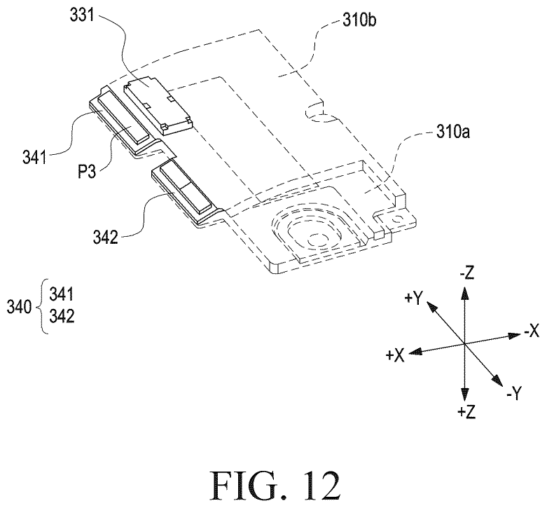

FIG. 12 is a perspective view illustrating a speaker assembly according to an embodiment of the disclosure.

FIG. 13 is a bottom view illustrating a speaker assembly according to an embodiment of the disclosure.

FIG. 14 is a bottom view illustrating a speaker assembly according to an embodiment of the disclosure.

Referring to FIGS. 12 and 13, a path through which sound emitted from the second speaker 331 is radiated may be defined as a third sound path P3.

According to an embodiment, the third sound path P3 may mean a path through which a sound emitted from the second speaker 331 passes through the first radiating portion 341 along the first opening O1 and is discharged. Since the first speaker 321 and the second speaker 331 are disposed in parallel in the second direction (e.g., the X-axis direction), portions of the first sound path P1 and the third sound path P3 may overlap.

According to an embodiment, the third sound path P3 may be a path through which the second acoustic signal is emitted from the second diaphragm and moves in the second direction perpendicular to the first direction, and is discharged through the first opening O1

In the present illustration and the following embodiment, an example is described in which the sound emitted from the second speaker 331 passes through the first radiating portion 341 and is discharged, and the third sound path P3 partially overlaps the first sound path P1, but the disclosure is not limited thereto, and the sound emitted from the second speaker 331 may pass through the second radiating portion 342 and the third sound path P3 may partially overlap the second sound path P2.

Referring to FIG. 14, according to an embodiment, the third sound path P3 may be disposed to at least partially overlap the above-described first sound path P1 and not to overlap the above-described second sound path P2. Further, the third sound path P3 may allow the second acoustic signal to be emitted to the outside of the electronic device through the first hole 2101a.

According to an embodiment, when viewed from above, the above-described first sound path P1 may be disposed to at least partially overlap the second speaker 331, and the above-described second sound path P2 may be disposed not to overlap the second speaker 331.

According to an embodiment, a keyboard and a touch pad received in the housing 210 to face the first front surface 210a may be further included, and the first speaker 321, the second speaker 331, the above-described first sound path P1, the above-described second sound path P2, and the third sound path P3 may be disposed not to overlap the keyboard and the touch pad when viewed from above.

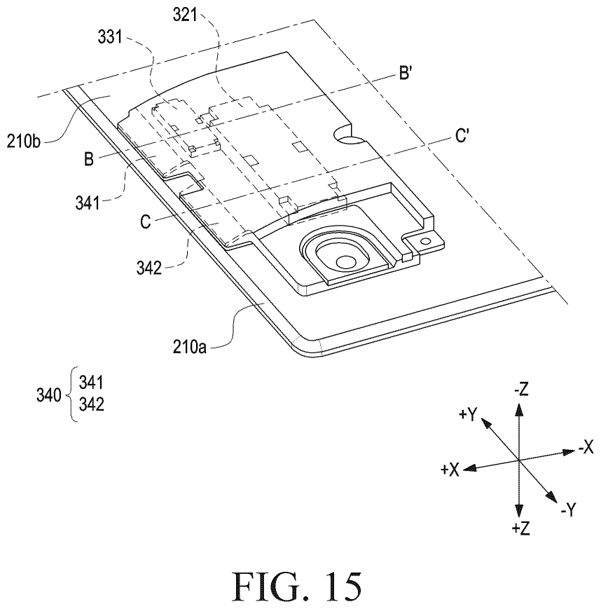

FIG. 15 is a perspective view illustrating a portion of an electronic device according to an embodiment of the disclosure.

FIG. 16 is a cross-sectional view illustrating an electronic device, taken along line B-B′ of FIG. 12 according to an embodiment of the disclosure.

FIG. 17 is a cross-sectional view illustrating an electronic device, taken along line C-C′ of FIG. 12 according to an embodiment of the disclosure.

Referring to FIGS. 15 and 16, the first sound path P1 and the third sound path P3 may partially overlap each other in the opening O1.

According to an embodiment, the third sound path P3 of the sound emitted from the second speaker 331 and the first sound path P1 of the sound emitted from the first speaker 321 may partially overlap. According to an embodiment, the first sound path P1 and the third sound path P3 may partially overlap in the first opening O1.

According to an embodiment, the first sound path P1 and the third sound path P3 may be separated by a guide plate 332. In the disclosure and the following embodiment, an example is described in which the guide plate 332 separates the third sound path P3 and the first sound path P1, but the disclosure is not limited thereto, and the first sound path P1 of the first speaker 321 and the third sound path P3 of the second speaker 331 may be separated by the speaker housing 310.

Further, the second speaker 331 that mainly reproduces a high-frequency sound may be disposed adjacent to the first radiating portion 341 and the first hole 2101a. Since the second speaker 331 and the first hole 2101a are disposed adjacent to each other, the length of the third sound path P3 may be very short.

Referring to FIG. 17, the second sound path P2 may not overlap the third sound path P3. According to an embodiment, the sound emitted from the first speaker 321 may move along the second opening O2 through the second sound path P2, pass through the second radiating portion 342, and be discharged to the outside of the electronic device 101 through the second hole 2101b.

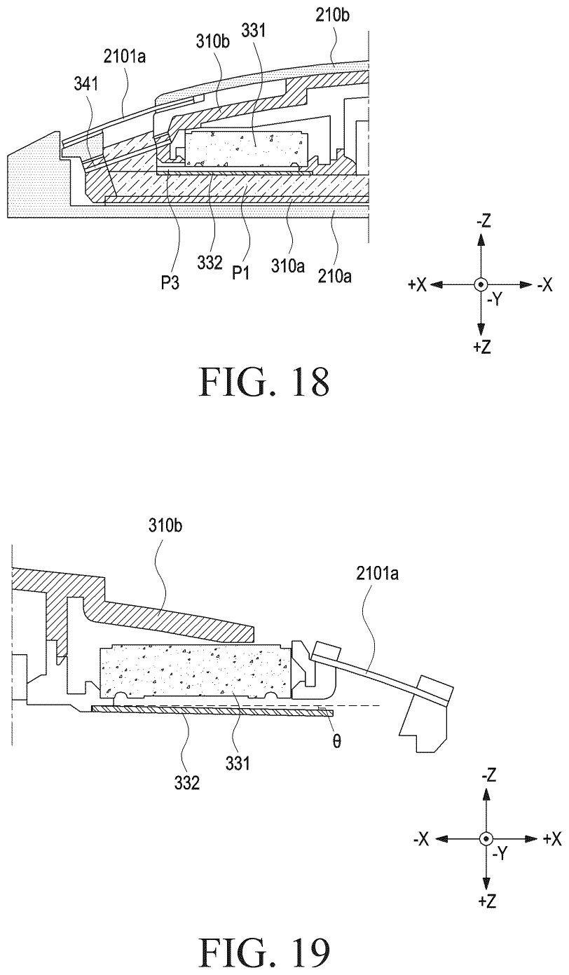

FIG. 18 is a cross-sectional view illustrating a portion of an electronic device according to an embodiment of the disclosure.

FIG. 19 is a cross-sectional view illustrating a portion of an electronic device according to an embodiment of the disclosure.

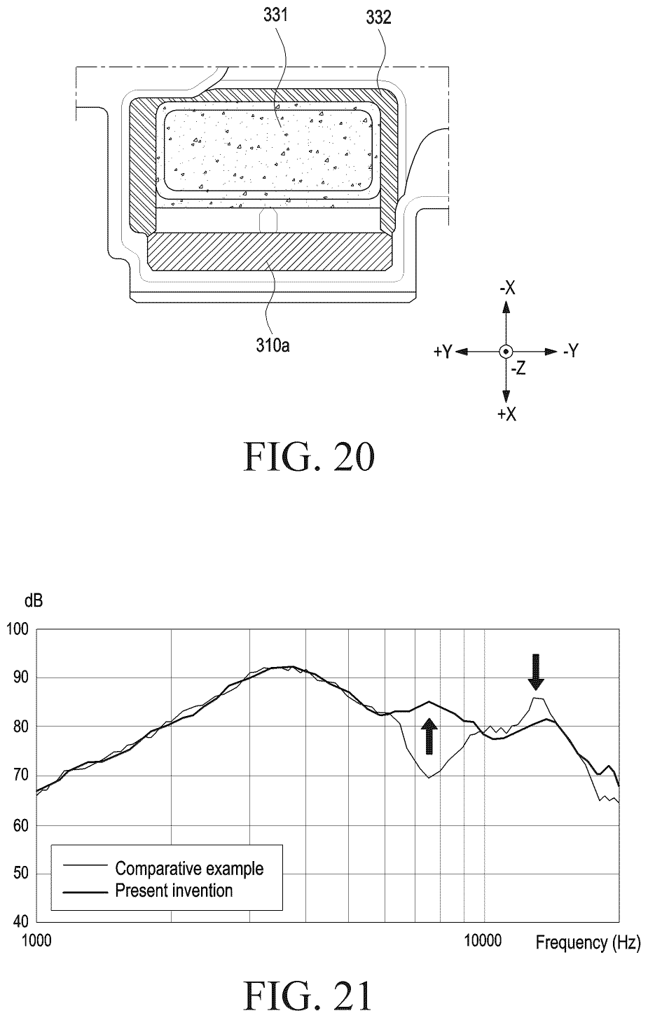

FIG. 20 is a plan view illustrating a partial cutaway of an electronic device according to an embodiment of the disclosure.

FIG. 21 is a graph illustrating comparison between a speaker assembly according to an embodiment of the disclosure.

Referring to FIGS. 18 and 19, the speaker assembly 300 may include a guide plate 332. The guide plate 332 may be configured to form the third sound path P3 of the second speaker 331. Further, the guide plate 332 may be configured to separate the third sound path P3 of the second speaker 331 from the sound path of the first speaker 321.

According to an embodiment, the thickness of the third sound path P3 may be configured to increase toward the first hole 2101a. In other words, the guide plate 332 may be inclined by a predetermined angle or more from the second direction (e.g., the X-axis direction). The predetermined angle θ may mean less than about 10 degrees, and as the guide plate 332 is inclined, the third sound path P3, which refers to a path through which sound emitted from the second speaker 331 moves, may also be inclined by less than about 10 degrees.

In the illustration and the following embodiment, an example is described in which the predetermined angle θ, which refers to the inclined angle of the guide plate 332, is 1 degree, but the disclosure is not limited thereto. For example, as described above, the predetermined angle θ may be set to less than 10 degrees, and the predetermined angle θ (e.g., up to 45 degrees) may be set according to the receivable area of the inner space of the speaker housing 310. Further, the predetermined angle θ (e.g., up to 45 degrees) may be set according to the amount of sound flow in the sound path and/or the third sound path P3 of the first speaker 321.

Referring to FIG. 19, the guide plate 332 may be coupled to at least a portion of the rear case 310b and extend in the second direction (e.g., the +X-axis direction). However, the coupling of the guide plate 332 is not limited thereto, and it may be coupled to the front case 310a, and at least a portion of the front case 310a and/or the rear case 310b may extend in the second direction (e.g., the X-axis direction).

According to an embodiment, the coupling method between the front case 310a and/or the rear case 310b of the guide plate 332 may be, e.g., using a double-sided tape, or may be a fusion method (e.g., a method using an adhesive, a coupling material, or a fusion material) where a portion of the speaker housing 310 is fused.

Referring to FIG. 20, when viewed from above, the above-described second speaker assembly 330 (e.g., the second speaker 331 and/or the guide plate 332) may overlap at least a portion of the front case 310a. Further, when viewed from above, at least a portion of the second speaker 331 may overlap the guide plate 332. Accordingly, the third sound path P3, which is a path through which the sound emitted from the second speaker 331 moves, may be separated from the sound path of the first speaker 321, which is a space between the guide plate 332 and the front case 310a. Further, the sound emitted from the second speaker 331 may be guided by the guide plate 332 in the second direction (e.g., the X-axis direction) and be discharged to the outside of the electronic device 101 along the third sound path P3.

FIG. 21 is a graph which compares a case where the guide plate 332 is inclined by a predetermined angle θ or more and a case the guide plate 332 has no inclination (e.g., comparative example). Referring to FIG. 18, when the guide plate 332 is inclined by the predetermined angle θ or more, distortion of high frequency performance may be minimized or decreased, and the frequency characteristics of sound emitted from the second speaker 331 may be planarized, as compared to the comparative example.

The high frequency performance may mean the ability of a speaker to process a high frequency signal. Therefore, speakers with minimal or decreased distortion of high frequency performance may have a good ability to accurately reproduce or process high frequency signals.

The frequency characteristic (also referred to as a frequency response) may refer to a feature describing how the electronic device 101 or the audio device processes a signal of a specific frequency. Therefore, when the frequency characteristic is planarized, it may mean that the distortion of the output signal (e.g., sound emitted from the speaker) is not large according to the frequency of the input signal.

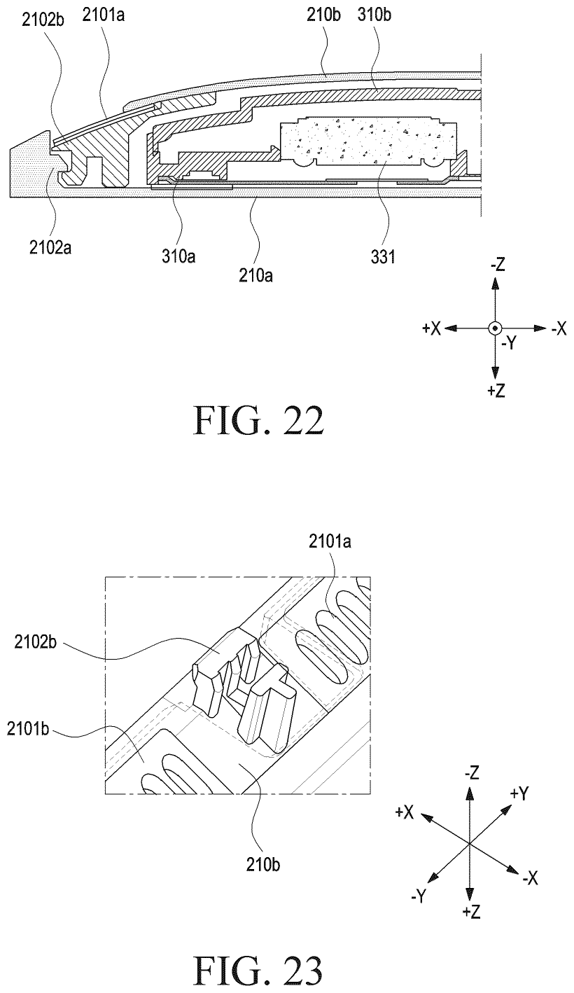

FIG. 22 is a cross-sectional view illustrating a portion of an electronic device according to an embodiment of the disclosure.

FIG. 23 is a perspective view illustrating a fastening portion of a rear case of an electronic device according to an embodiment of the disclosure.

Referring to FIGS. 22 and 23, the housing 210 may include a hook portion 2102b disposed between the first hole 2101a and the second hole 2101b to fix the speaker housing 310 to the housing 210.

In the present illustration and the following embodiment, an example is described in which the fastening portion 2102 is fastened through the hook structure, but the disclosure is not limited thereto, and it may be fastened through a general fastening method which may generate a coupling force between the front case 310a and the rear case 310b of the speaker housing 310, such as a screw fastening method, a bolt fastening method, a rivet fastening method, and/or a fastening method using an adhesive.

According to an embodiment, the fastening portion 2102 may include a hook portion 2102b protruding toward the housing 210 (e.g., the second direction) from a separation wall formed between the first sound path P1 and the second sound path P2 and an engagement recess 2102a configured to receive the hook portion 2102b.

The hook portion 2102b may have a structure where at least two protrusions are formed in the second direction (e.g., the +X-axis direction), and the engagement recess 2102a may be projected in a direction (e.g., the-X-axis direction) opposite to the direction where the hook portion 2102b protrudes, and may be inserted between the at least two protrusions. When the engagement recess 2102a is inserted into the hook portion 2102b, vibration of the speaker assembly 300 in the first direction (e.g., the Z-axis direction) may be minimized or decreased.

According to an embodiment, the engagement recess 2102a may be at least a portion of the front surface 210a of the electronic device 101, and the hook portion 2102b may be at least a portion of the rear surface 210b of the electronic device 101. Although an example is described in which the fastening portion 2102 is a portion of the housing 210 in the disclosure and the following embodiment, the disclosure is not limited thereto. For example, the configurations of the hook portion 2102b and the engagement recess 2102a may be formed inside the speaker assembly 300 if it has a structure that may minimize the vibration of the speaker assembly 300 and mitigate the vibration of sound.

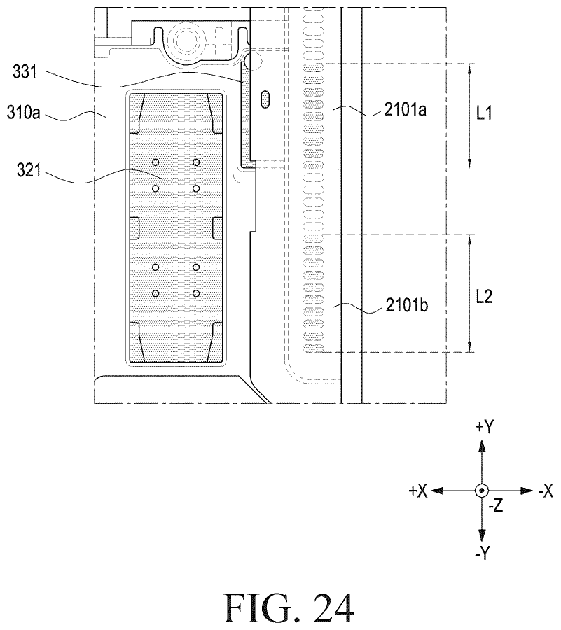

FIG. 24 is a plan view illustrating a portion of an electronic device according to an embodiment of the disclosure.

Referring to FIG. 24, the first hole 2101a and the second hole 2101b may have a structure where a plurality of holes are formed in the third direction (e.g., the Y-axis direction). According to an embodiment, the length where the plurality of holes of the first hole 2101a extend in the third direction (e.g., the Y-axis direction) may be referred to as a first length L1. Further, the length where the plurality of holes of the second hole 2101b extend in the third direction (e.g., the Y-axis direction) may be referred to as a second length L2.

According to an embodiment, the first length L1 of the first hole 2101a may be shorter than the second length L2 of the second hole 2101b. For example, the second length L2 may be formed to be about 1.1 times the first length L1. Accordingly, a phenomenon where the sound emitted from the first speaker 321 and the sound emitted from the second speaker 331 in the first opening O1 of the first hole 2101a overlap may be decreased.

FIG. 25 is a plan view and a partially enlarged view illustrating an electronic device according to an embodiment of the disclosure.

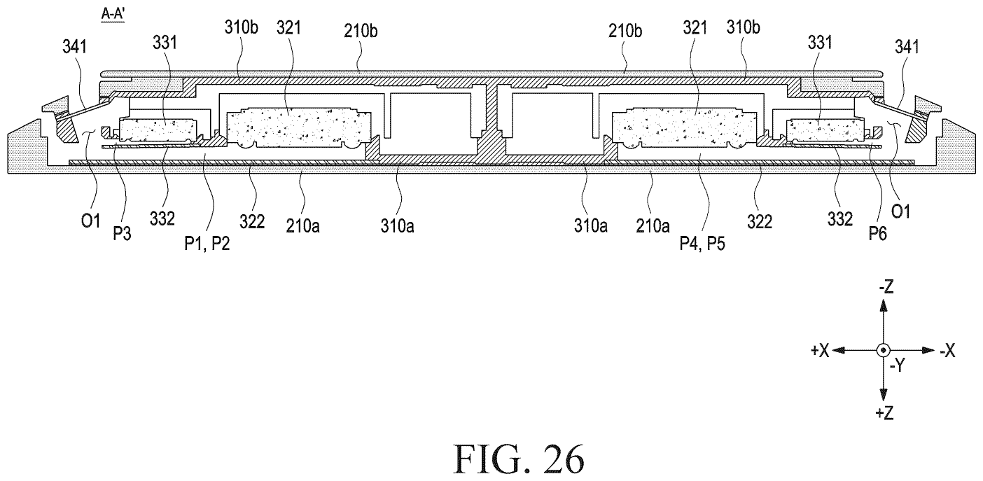

FIG. 26 is a cross-sectional view illustrating an electronic device according to an embodiment of the disclosure.

Referring to FIGS. 25 and 26, the speaker assembly 300 may be applied to various electronic devices 101. For example, the speaker assembly 300 of the disclosure may be applied if the first speaker 321 and the second speaker 331 are disposed adjacent to each other so that the sound path of the first speaker 321 may overlap at least a portion of the third sound path P3.

Although the electronic device 101 disclosed in the disclosure is an electronic device where a plurality of housings are connected by a hinge structure, such as a laptop computer, the disclosure is not limited thereto. For example, the electronic device 101 may be an electronic device having a bar type or a plate type exterior.

According to an embodiment, as described above in FIG. 4, a third hole 2101c and a fourth hole 2101d may be formed on the opposite side of the one end portion of the electronic device 101 where the first hole 2101a and the second hole 2101b are formed. The third hole 2101c may be a component for transferring sound emitted from the third speaker and/or the fourth speaker to the outside, and the fourth hole 2101d may be a component for transferring sound emitted from the third speaker to the outside.

Further, a plurality of speaker assemblies 300 may be formed inside the electronic device 101. For example, speaker assemblies may be formed at two opposite end portions of the electronic device 101 in the second direction (e.g., the X-axis direction). In the disclosure and the following embodiment, an example is described in which speaker assemblies 300 are formed at two opposite end portions of the electronic device 101 in the second direction (e.g., the X-axis direction), but the disclosure is not limited thereto, and they may be formed at various positions which may be one end portion of the electronic device 101, which may be adjusted according to specific functional requirements or design purposes.

The disclosure relates to an electronic device. According to an embodiment of the disclosure, an electronic device 101 may comprise a first housing 210 configured to form an exterior of the electronic device and a speaker assembly 300. The speaker assembly may include a speaker housing 310 including a front case 310a and a rear case 310b coupled to the front case to form an inner space, a first speaker assembly 320 emitting a sound corresponding to a first frequency range and a second speaker assembly 330 emitting a sound corresponding to a second frequency range at least partially different from the first frequency range. The first speaker assembly may include a first speaker 321 disposed to be spaced apart from one end portion of the electronic device and a first plate 322 disposed over the front case and guiding a sound emitted from the first speaker to a first opening O1 and a second opening O2 through a sound path of the first speaker 321. The second speaker assembly may include a second speaker 331 disposed adjacent to a portion of the first speaker between an end portion of the electronic device and the first speaker and a guide plate 332 disposed over to be spaced apart from the first plate by a predetermined distance to guide a sound emitted from the second speaker to the first opening O1 through a third sound path P3. At least a portion of the sound path of the first speaker 321 may be disposed to at least partially overlap the third sound path P3 when viewed from above.

According to an embodiment, in the electronic device, the sound path of the first speaker 321 may include a first sound path P1 disposed to at least partially overlap the third sound path P3 when viewed from above and a second sound path P2 disposed not to overlap the third sound path P3 when viewed from above.

According to an embodiment, in the electronic device, the first housing 210 may further include a fastening portion 2102 which connects the front case and the rear case, and the fastening portion 2102 may be formed between the first opening O1 and the second opening O2.

According to an embodiment, in the electronic device, an end portion of the guide plate 332 may be coupled to the rear case, and the angle between the first plate 322 and the guide plate 332 may be 1 degree or more and 45 degrees or less.

According to an embodiment, in the electronic device, the third sound path P3 and the sound path of the first speaker 321 may be separated by the guide plate 332.

According to an embodiment, in the electronic device, the fastening portion 2102 may couple the front case and the rear case through screwing.

According to an embodiment, in the electronic device, the first speaker 321 may emit sound in a low frequency range.

According to an embodiment, in the electronic device, the second speaker 331 may emit sound in a high frequency range.

According to an embodiment, in the electronic device, an end portion of the first plate 322 may be configured to extend up to the first opening O1 and/or the second opening O2.

According to an embodiment, in the electronic device, the guide plate 332 may be configured so that an end portion thereof extends up to the first opening O1.

According to an embodiment, in the electronic device, the first housing 210 may include a first front surface and a first rear surface, and transfer sound to the outside of the electronic device through a hole 2101 formed in the first rear surface 210b.

According to an embodiment, in the electronic device, the hole 2101 may include a first hole 2101a for transmitting sound emitted from the first speaker and the second speaker to the outside of the electronic device and/or a second hole 2101b for transmitting sound emitted from the first speaker to the outside of the electronic device.

According to an embodiment, in the electronic device, the speaker assembly 300 may be configured to be formed at two opposite ends of the electronic device 101.

According to an embodiment, in the electronic device, the first speaker 321 may be supported and fixed by the front case and/or the rear case.

According to an embodiment, in the electronic device, the second speaker 331 may be supported and fixed by the front case and/or the rear case.

The disclosure relates to a speaker assembly. According to an embodiment of the disclosure, a speaker assembly 300 may comprise a speaker housing 310 configured to form an inner space, a first speaker assembly 320, and a second speaker assembly 330. The first speaker assembly may include a first speaker 321 disposed to be spaced apart from an end portion of the electronic device and a first plate 322 guiding a sound emitted from the first speaker to a first opening O1 and a second opening O2 through a sound path of the first speaker 321. The second speaker assembly may include a second speaker 331 disposed adjacent to a portion of the first speaker between an end portion of the electronic device and the first speaker and a guide plate 332 disposed over to be spaced apart from the first plate 322 by a predetermined distance and guiding a sound emitted from the second speaker to the first opening O1 through a third sound path P3. The sounds emitted from the first speaker 321 and the second speaker 331 may overlap each other in the first opening O1.

According to an embodiment, in the speaker assembly, the speaker housing 310 may further include a fastening portion 2102.

According to an embodiment, in the speaker assembly, the guide plate 332 may be coupled to the rear case, and be configured to form an angle of 5 degree or more and 10 degrees or less with respect to a plane perpendicular to the first direction.

The disclosure relates to an electronic device. According to an embodiment of the disclosure, an electronic device 101 may comprise a first housing 210 configured to form an exterior of the electronic device and a speaker assembly 300. The speaker assembly may include a speaker housing 310 including a front case 310a and a rear case 310b coupled to the front case to form an inner space, a first speaker assembly 320 emitting a sound corresponding to a first frequency range and a second speaker assembly 330 emitting a sound corresponding to a second frequency range at least partially different from the first frequency range. The first speaker assembly may include a first speaker 321 disposed to be spaced apart from one end portion of the electronic device and a first plate 322 disposed over the front case and guiding a sound emitted from the first speaker to a first opening O1 and a second opening O2 through a sound path of the first speaker 321. The second speaker assembly may include a second speaker 331 disposed adjacent to a portion of the first speaker between an end portion of the electronic device and the first speaker and a guide plate 332 disposed over to be spaced apart from the first plate by a predetermined distance to guide a sound emitted from the second speaker to the first opening O1 through a third sound path P3. At least a portion of the sound path of the first speaker 321 may be disposed to at least partially overlap the third sound path P3 when viewed from above. The sounds emitted from the first speaker 321 and the second speaker 331 may overlap each other in the first opening, and the coupling between the front case and the rear case may be made by a fastening portion 2102 formed in the first housing 210.

According to an embodiment, in the electronic device, the guide plate 332 may be coupled to the rear case, and be configured to form an angle of 5 degree or more and 10 degrees or less with respect to a plane perpendicular to the first direction.

The disclosure relates to an electronic device. According to an embodiment of the disclosure, there may be provided an electronic device 101 comprising a housing 210 including a first hole 2101a and a second hole 2101b, a first speaker 321 configured to generate a first acoustic signal corresponding to a first frequency range and a second speaker 331 generating a second acoustic signal corresponding to a second frequency range at least partially different from the first frequency range, wherein a first sound path P1 formed between the first hole and the first speaker allows a first portion of the first acoustic signal to be emitted to an outside of the electronic device through the first hole 2101a, and a second sound path P2 formed between the second hole and the first speaker allows a second portion of the first acoustic signal to be emitted to the outside of the electronic device through the second hole 2101b, wherein a third sound path P3 formed between the first hole 2101a and the second speaker and disposed to at least partially overlap the first sound path P1 when viewed from above and disposed not to overlap the second sound path P2 when viewed from above allows the second acoustic signal to be emitted to the outside of the electronic device through the first hole 2101a.

According to an embodiment, in the electronic device, the first speaker 321 and the second speaker 331 may be configured to form a speaker assembly 300. The speaker assembly may include a speaker housing 310 receiving the first speaker and the second speaker and configured to form at least a portion of the first sound path P1, at least a portion of the second sound path P2, and at least a portion of the third sound path P3.

According to an embodiment, in the electronic device, the speaker assembly 300 may include a guide plate. The guide plate may separate the first sound path P1 and the third sound path P3 from each other and be configured to be inclined with respect to the second speaker. A height of the third sound path P3 may increase toward the first hole 2101a.

According to an embodiment, in the electronic device, the second speaker 331 may be positioned between the first hole 2101a and the first speaker 321 when viewed from above.

According to an embodiment, the first sound path P1 may be disposed to at least partially overlap the second speaker 331 when viewed from above, and the second sound path P2 may be disposed not to overlap the second speaker 331 when viewed from above.

According to an embodiment, in the electronic device, the first sound path P1 may be disposed between the third sound path P3 and the first front surface 210a of the housing 210.

According to an embodiment, in the electronic device, the housing 210 may include a fastening portion 2102 disposed between the first hole 2101a and the second hole 2101b to fix the speaker housing 310 to the housing 210.

According to an embodiment, in the electronic device, the fastening portion 2102 may include a hook portion 2102b protruding toward the housing from a separation wall formed between the first sound path P1 and the second sound path P2 and an engagement recess 2012a configured to receive the hook portion 2102b.

According to an embodiment, in the electronic device, the first rear surface 210b of the housing 210 may include a planar area and a curved area extending from an end portion of the planar area. Each of the first hole 2101a and the second hole 2101b may be formed in the curved area.

According to an embodiment, in the electronic device, a keyboard and a touchpad may be further included which are received toward the first front surface 210a in the housing 210. The first speaker 321, the second speaker 331, the first sound path P1, the second sound path P2, and the third sound path P3 may be disposed not to overlap the keyboard and the touchpad when viewed from above.

According to an embodiment, in the electronic device, the first hole 2101a may include a first plurality of holes, and the second hole 2101b may include a second plurality of holes.

According to an embodiment, in the electronic device, the housing 210 may further include a first mesh member covering the first hole 2101a and a second mesh member covering the second hole 2101b. A first plurality of holes aligned with the first hole 2101a may be formed in the first mesh member, and a second plurality of holes aligned with the second hole 2101b may be formed in the second mesh member.

According to an embodiment, in the electronic device, the first hole 2101a may be smaller than the second hole 2101b.

According to an embodiment, in the electronic device, the first frequency range may be lower than the second frequency range.

According to an embodiment, in the electronic device, the first speaker 321 may be configured to form a woofer, and the second speaker 331 may be configured to form a tweeter.

According to an embodiment, in the electronic device, the area of the first speaker 321 may be larger than the area of the second speaker 331.

According to an embodiment, in the electronic device, the guide plate 332 may include a different material from that of the speaker housing 310.

According to an embodiment, in the electronic device, the first hole 2101a and the second hole 2101b may be formed at an end portion of the electronic device. The housing 210 may further include a third hole 2101c and a fourth hole 2101d formed at the end portion opposite to the end portion where the first hole 2101a and the second hole 2101b are formed. The electronic device 101 may comprise a third speaker configured to generate a third acoustic signal corresponding to the first frequency range and a fourth speaker configured to generate a fourth acoustic signal corresponding to the second frequency range. A fourth sound path P4 formed between the third hole and the third speaker may allow a first portion of the third acoustic signal to be emitted to the outside of the electronic device through the third hole 2101c, and a fifth sound path P5 formed between the fourth hole and the third speaker may allow a second portion of the third acoustic signal to be emitted to the outside of the electronic device through the fourth hole 2101d. A sixth sound path P6 formed between the third hole 2101c and the fourth speaker and disposed to at least partially overlap the fourth sound path P4 when viewed from above and disposed not to overlap the fifth sound path P5 when viewed from above may allow the fourth acoustic signal to be emitted to the outside of the electronic device through the third hole 2101c.

The disclosure relates to an electronic device. According to an embodiment of the disclosure, there may be provided an electronic device 101 comprising a housing 210 including a first hole 2101a and a second hole 2101b and a speaker assembly 300 including a first speaker 321 configured to generate a first acoustic signal corresponding to a first frequency range and a second speaker 331 generating a second acoustic signal corresponding to a second frequency range at least partially different from the first frequency range, wherein a first sound path P1 formed between the first hole and the first speaker allows a first portion of the first acoustic signal to be emitted to an outside of the electronic device through the first hole 2101a, a second sound path P2 formed between the second hole and the first speaker allows a second portion of the first acoustic signal to be emitted to the outside of the electronic device through the second hole 2101b, a third sound path P3 formed between the first hole 2101a and the second speaker allows the second acoustic signal to be emitted to the outside through the first hole 2101a, and the second speaker is disposed to at least partially overlap the first sound path 1 when viewed from above and not to overlap the second sound path P2 when viewed from above.

According to an embodiment, there may be provided the electronic device 101, wherein the first sound path P1 is disposed between the third sound path P3 and the first front surface 210a of the housing 210.

The disclosure relates to an electronic device. According to an embodiment of the disclosure, there may be provided an electronic device 101 comprising a first housing 210, a speaker housing 310 disposed in the first housing, the speaker housing including a front case 310a and a rear case 310b which is configured to combine with the front case to form an inner space, a first speaker assembly 320 disposed in the speaker housing 310, including a first speaker 321, which includes a first diaphragm facing in a first direction, and configured to generate a first acoustic signal corresponding to a first frequency range, and a second speaker assembly 330 disposed in the speaker housing 310, including a second speaker 331, which includes a second diaphragm facing in the first direction, and configured to generate a second acoustic signal corresponding to a second frequency range at least partially different from the first frequency range, wherein a first sound path P1 is configured to allow the first acoustic signal to pass therethrough, extends from the first diaphragm toward a first opening O1 in a second direction perpendicular to the first direction and is formed with a portion of the front case 310a, wherein the second speaker 331 is disposed over the first sound path P1, wherein a guide plate 332 is disposed between the first sound path P1 and the second speaker 331, a portion of the guide plate 332 configured to support the second speaker 331, and wherein a third sound path P3 is configured to allow the second acoustic signal to pass therethrough, extends from the second diaphragm toward the first opening O1 in the second direction and is formed with a portion of the guide plate. According to an embodiment, there may be provided the electronic device, wherein a second sound path P2 is configured to allow a portion of the first acoustic signal to pass therethrough, and extends from the first diaphragm toward a second opening O2 spaced apart from the first opening O1, and wherein the first sound path P1 is disposed to at least partially overlap the third sound path P3 when viewed from above, and wherein the second sound path P2 is disposed to not overlap the third sound path P3 when viewed from above.

According to an embodiment, there may be provided the electronic device, wherein the first housing 210 further includes a fastening portion 2102 which connects the front case and the rear case, and wherein the fastening portion 2102 is formed between the first opening O1 and the second opening O2.

According to an embodiment, there may be provided the electronic device, wherein one end of the guide plate 332 is coupled to the rear case, and configured to form an angle of 1 degree or more and 45 degrees or less with respect to a plane perpendicular to the first direction.

According to an embodiment, there may be provided the electronic device, wherein the guide plate 332 is configured to separate the first sound path P1 and the second sound path P2, which are sound paths of the first speaker 321, from the third sound path P3, which is a sound path of the second speaker 331.

According to an embodiment, there may be provided the electronic device, wherein the front case 310a further includes a first plate 322 configured to extend to the first opening O1 and the second opening O2.

According to an embodiment, there may be provided the electronic device, wherein the guide plate 332 is formed to be spaced apart from the first plate 322 and is disposed to overlap at least a portion of the first plate 322 when viewed from above.

According to an embodiment, there may be provided the electronic device, wherein the second speaker disposed adjacent to a portion of the first speaker between an end portion of the electronic device and the first speaker.

According to an embodiment, there may be provided the electronic device, wherein the guide plate is disposed over to be spaced apart from a first plate by a predetermined distance.

The disclosure relates to a speaker assembly. According to an embodiment of the disclosure, there may be provided a speaker assembly 300 comprising a speaker housing 310 configured to form an inner space, a first speaker assembly 320 disposed in the speaker housing 310, including a first speaker 321, which includes a first diaphragm facing in a first direction, and configured to generate a first acoustic signal corresponding to a first frequency range, and a second speaker assembly 330 disposed in the speaker housing 310, including a second speaker 331, which includes a second diaphragm facing in the first direction, and configured to generate a second acoustic signal corresponding to a second frequency range at least partially different from the first frequency range, wherein a first sound path P1 is configured to allow the first acoustic signal to pass therethrough, extends from the first diaphragm toward a first opening O1 in a second direction perpendicular to the first direction and is formed with a portion of the speaker housing 310, wherein the second speaker 331 is disposed over the first sound path P1, wherein a guide plate 332 is disposed between the first sound path P1 and the second speaker 331, a portion of the guide plate 332 configured to support the second speaker 331, and wherein a third sound path P3 is configured to allow the second acoustic signal to pass therethrough, extends from the second diaphragm toward the first opening O1 in the second direction and is formed with a portion of the guide plate.

The disclosure relates to an electronic device. According to an embodiment of the disclosure, there may be provided an electronic device 101 comprising a first housing 210, a speaker housing 310 disposed in the first housing, the speaker housing including a front case 310a and a rear case 310b which is configured to combine with the front case to form an inner space, a first speaker assembly 320 disposed in the speaker housing 310, including a first speaker 321, which includes a first diaphragm facing in a first direction, and configured to generate a first acoustic signal corresponding to a first frequency range, and a second speaker assembly 330 disposed in the speaker housing 310, including a second speaker 331, which includes a second diaphragm facing in the first direction, and configured to generate a second acoustic signal corresponding to a second frequency range at least partially different from the first frequency range, wherein a first sound path P1 is configured to allow the first acoustic signal to pass therethrough, extends from the first diaphragm toward a first opening O1 in a second direction perpendicular to the first direction and is formed with a portion of the front case 310a, wherein the second speaker 331 is disposed over the first sound path P1, wherein a guide plate 332 is disposed between the first sound path P1 and the second speaker 331, a portion of the guide plate 332 configured to support the second speaker 331, wherein a third sound path P3 is configured to allow the second acoustic signal to pass therethrough, extends from the second diaphragm toward the first opening O1 in the second direction and is formed with a portion of the guide plate, and wherein the front case and the rear case are coupled to each other by a fastening portion 2102 formed in the first housing 210.

According to an embodiment, there may be provided an electronic device 101 including a speaker assembly 300 long in the third direction (e.g., the Y-axis direction) despite the limited inner space of the electronic device 101.

According to an embodiment, there may be provided an electronic device 101 that may enhance sound quality and sound volume by securing a size in the third direction (e.g., the Y-axis direction) of the speaker assembly 300 and efficiently utilize the mounting space by allowing the sound paths P of the sounds emitted from a plurality of speaker assemblies 300 to partially overlap each other.

It is apparent to one of ordinary skill in the art that the electronic device 101 cover described above with reference to an embodiment of the disclosure as described above are not limited to the above-described embodiments and those shown in the drawings, and various changes, modifications, or alterations may be made thereto without departing from the scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing;
a speaker housing disposed in the first housing, the speaker housing including:
a front case, and
a rear case which is configured to combine with the front case to form an inner space;
a first speaker assembly disposed in the speaker housing, including a first speaker, which includes a first diaphragm facing in a first direction, and configured to generate a first acoustic signal corresponding to a first frequency range; and
a second speaker assembly disposed in the speaker housing, including a second speaker, which includes a second diaphragm facing in the first direction, and configured to generate a second acoustic signal corresponding to a second frequency range at least partially different from the first frequency range,
wherein a first sound path is configured to allow the first acoustic signal to pass therethrough, extends from the first diaphragm toward a first opening in a second direction perpendicular to the first direction, and is formed with a portion of the front case,
wherein the second speaker is disposed over the first sound path,
wherein a guide plate is disposed between the first sound path and the second speaker, and a portion of the guide plate is configured to support the second speaker, and
wherein a third sound path is configured to allow the second acoustic signal to pass therethrough, extends from the second diaphragm toward the first opening in the second direction, and is formed with a portion of the guide plate.

2. The electronic device of claim 1,
wherein a second sound path is configured to allow a portion of the first acoustic signal to pass therethrough, and extends from the first diaphragm toward a second opening spaced apart from the first opening,
wherein the first sound path is disposed to at least partially overlap the third sound path when viewed from above, and
wherein the second sound path is disposed to not overlap the third sound path when viewed from above.

3. The electronic device of claim 2,
wherein the first housing further includes a fastening portion which connects the front case and the rear case, and
wherein the fastening portion is formed between the first opening and the second opening.

4. The electronic device of claim 3, wherein one end of the guide plate is coupled to the rear case, and configured to form an angle of 1 degree or more and 45 degrees or less with respect to a plane perpendicular to the first direction.

5. The electronic device of claim 4, wherein the guide plate is configured to separate the first sound path and the second sound path, which are sound paths of the first speaker, from the third sound path, which is a sound path of the second speaker.

6. The electronic device of claim 3, wherein the fastening portion connects the front case and the rear case through a hook structure.

7. The electronic device of claim 1, wherein the first speaker is configured to emit sound in the first frequency range of 20Hz to 200Hz.

8. The electronic device of claim 1,
wherein the second speaker is configured to emit sound in the second frequency range, and
wherein a maximum value of the second frequency range is greater than a maximum value of the first frequency range.

9. The electronic device of claim 1, wherein the front case further includes a first plate configured to extend to the first opening and the second opening.

10. The electronic device of claim 1, wherein the guide plate is configured to extend to the first opening.

11. The electronic device of claim 9, wherein the guide plate is formed to be spaced apart from the first plate and is disposed to overlap at least a portion of the first plate when viewed from above.

12. The electronic device of claim 1, wherein the first housing includes a first front side and a first rear side, and configured to transmit sound through a hole formed in the first rear side to an outside of the electronic device.

13. The electronic device of claim 12, wherein the hole includes:
a first hole for transmitting sound emitted from the first speaker and the second speaker to an outside of the electronic device; and
a second hole for transmitting sound emitted from the first speaker to the outside of the electronic device.

14. The electronic device of claim 1, wherein the first speaker is fixed to the front case or the rear case.

15. The electronic device of claim 1, wherein the second speaker is fixed to the front case or the rear case.

16. A speaker assembly, comprising:
a speaker housing configured to form an inner space;
a first speaker assembly disposed in the speaker housing, including a first speaker, which includes a first diaphragm facing in a first direction, and configured to generate a first acoustic signal corresponding to a first frequency range; and
a second speaker assembly disposed in the speaker housing, including a second speaker, which includes a second diaphragm facing in the first direction, and configured to generate a second acoustic signal corresponding to a second frequency range at least partially different from the first frequency range,
wherein a first sound path is configured to allow the first acoustic signal to pass therethrough, extends from the first diaphragm toward a first opening in a second direction perpendicular to the first direction, and is formed with a portion of the speaker housing,
wherein the second speaker is disposed over the first sound path,
wherein a guide plate is disposed between the first sound path and the second speaker, a portion of the guide plate configured to support the second speaker, and
wherein a third sound path is configured to allow the second acoustic signal to pass therethrough, extends from the second diaphragm toward the first opening in the second direction, and is formed with a portion of the guide plate.

17. The speaker assembly of claim 16, wherein the speaker housing further includes a fastening portion.

18. The speaker assembly of claim 16, wherein one end of the guide plate is coupled to a rear case, and configured to form an angle of 5 degree or more and 10 degrees or less with respect to a plane perpendicular to the first direction.

19. An electronic device, comprising:
a first housing;
a speaker housing disposed in the first housing, the speaker housing including:
a front case, and
a rear case which is configured to combine with the front case to form an inner space;
a first speaker assembly disposed in the speaker housing, including a first speaker, which includes a first diaphragm facing in a first direction, and configured to generate a first acoustic signal corresponding to a first frequency range; and
a second speaker assembly disposed in the speaker housing, including a second speaker, which includes a second diaphragm facing in the first direction, and configured to generate a second acoustic signal corresponding to a second frequency range at least partially different from the first frequency range,
wherein a first sound path is configured to allow the first acoustic signal to pass therethrough, extends from the first diaphragm toward a first opening in a second direction perpendicular to the first direction, and is formed with a portion of the front case,
wherein the second speaker is disposed over the first sound path,
wherein a guide plate is disposed between the first sound path and the second speaker, and a portion of the guide plate is configured to support the second speaker,
wherein a third sound path is configured to allow the second acoustic signal to pass therethrough, extends from the second diaphragm toward the first opening in the second direction, and is formed with a portion of the guide plate, and
wherein the front case and the rear case are coupled to each other by a fastening portion formed in the first housing.

20. The electronic device of claim 19, wherein one end of the guide plate is coupled to the rear case, and configured to form an angle of 5 degree or more and 10 degrees or less with respect to a plane perpendicular to the first direction.
